(19) United States
(12) Patent Application Publication
(10) Pub. No.: US 2025/0083723 A1
(43) Pub. Date: Mar. 13, 2025

(54) WIRELESS LOCOMOTIVE EMERGENCY STOP SYSTEMS

(71) Applicant: Cattron North America, Inc., Warren, OH (US)

(72) Inventor: Richard Allen Evans, Brookfield, OH (US)

(21) Appl. No.: 18/830,952

(22) Filed: Sep. 11, 2024

Related U.S. Application Data
(60) Provisional application No. 63/546,079, filed on Oct. 27, 2023.
(60) Provisional application No. 63/539,046, filed on Sep. 18, 2023.
(60) Provisional application No. 63/538,020, filed on Sep. 12, 2023.

(51) Int. Cl. B61L 99/00; B61C 15/00; B61L 15/00

(52) U.S. Cl. CPC B61L 99/002; B61C 15/00; B61L 15/0027; B61L 2201/00

(57) ABSTRACT

According to various aspects, exemplary embodiments are disclosed herein of wireless locomotive emergency stop systems. Also disclosed are exemplary methods of providing locomotives with wireless emergency stop systems, and exemplary methods of operating wireless locomotive emergency stop systems.

### CROSS-REFERENCE TO RELATED APPLICATIONS

This application claims priority to and the benefit of U.S. Provisional Patent Application No. 63/546,079 filed Oct. 27, 2023, U.S. Provisional Patent Application No. 63/539,046 filed Sep. 18, 2023, and U.S. Provisional Patent Application No. 63/538,020 filed Sep. 12, 2023. The entire disclosures of the above applications are incorporated herein by reference.

### FIELD

The present disclosure generally relates to wireless locomotive emergency stop systems.

### BACKGROUND

This section provides background information related to the present disclosure which is not necessarily prior art.

Remote control locomotive (RCL) systems enable rail operators to remotely control operation of locomotives. For example, a rail operator may use an RCL system to remotely control starting, stopping, speed, braking, switching, etc. of a locomotive. But not all locomotives are equipped with RCL systems.

### DRAWINGS

The drawings described herein are for illustrative purposes only of selected embodiments and not all possible implementations, and are not intended to limit the scope of the present disclosure.

FIG. 1 shows a locomotive handheld wireless emergency stop (E-Stop) device (broadly, a wireless radio frequency (RF) controller) according to an exemplary embodiment.

FIG. 2 shows a complete machine control unit (MCU) system that will be onboard a locomotive (e.g., mounted in the cab of the locomotive, etc.) according to an exemplary embodiment.

FIG. 3 shows the locomotive Machine Control Unit (MCU), which is part of the overall MCU system shown in FIG. 2.

### DETAILED DESCRIPTION

Example embodiments will now be described more fully with reference to the accompanying drawings.

As noted above, remote control locomotive (RCL) systems enable rail operators to remotely control operation of locomotives. For example, a rail operator may use an RCL system to remotely control starting, stopping, speed, braking, switching, etc. of a locomotive. But not all locomotives are equipped with RCL systems.

In exemplary embodiments disclosed herein, a wireless locomotive emergency stop system is configured to be operable as a standalone system without requiring the locomotive to be equipped with a remote control locomotive (RCL) system. Advantageously, the wireless locomotive emergency stop system can be used in locomotives that do not have a radio remote control locomotive system as well as in locomotives that are equipped with a radio remote control system.

In an exemplary embodiment, the wireless locomotive emergency stop system comprises a wireless RF controller (e.g., an Operator Control Unit (OCU), emergency stop (E-Stop) device etc.) and a Machine Control Unit (MCU). The wireless RF controller is portable and configured to be worn, located on, or otherwise carried by the person that requires additional safety when working on, near, on top of rail cars, under rail cars, or in any railroad operations where the person is not controlling the movement of the locomotive. The wireless RF controller is configured to continuously transmit RF signals reporting normal operation to the MCU located onboard the locomotive, that is, until an emergency stop switch of the wireless RF controller is activated. At which point, the wireless RF controller is configured to transmit an RF signal reporting activation of the emergency stop switch to the MCU in response to activation of the emergency stop switch. The MCU may be mounted inside of the cab of the locomotive.

Continuing with this exemplary embodiment, the MCU includes two distinct connections to the locomotive. One connection is pneumatic, and the other connection is electrical. The pneumatic connection is configured to be connected in parallel with the fireman's emergency brake handle. This pneumatic connection provides a failsafe by means of connecting a normally open pneumatic valve in parallel to the fireman's emergency brake handle. The wireless RF controller when active will communicate (e.g., via a two-way or bi-directional communication path, etc.) to the MCU commanding the pneumatic valve closed, thus preventing air from venting to atmosphere on the brake pipe of the locomotive.

The MCU includes a single electromechanical relay that will interface to the generator field circuit of the locomotive. When the overall MCU system is active, the relay will interrupt the VDC (e.g., 72vdc, etc.) from turning on the battery field of the locomotive, thereby preventing locomotive tractive effort. Continuing with this exemplary embodiment, the electromechanical relay is a normally open relay contact that interfaces to the generator field switch and battery field circuit.

In exemplary embodiments, the portable wireless RF controller is configured to continuously transmit RF signals reporting normal operation to the MCU located onboard the locomotive, unless the wireless RF controller's emergency stop switch is activated (e.g., depressed, etc.). The RF signal reporting normal operation that is transmitted by the wireless RF controller to the MCU will command the MCU to close the normally open pneumatic valve that is connected in parallel to the fireman's emergency brake. The closing of the normally open pneumatic valve will prevent any air from venting to atmosphere on the brake pipe of the locomotive, such that there is no braking force applied.

When the wireless RF controller's emergency stop switch is activated (e.g., depressed, etc.) by an operator carrying the portable wireless RF controller or other person, the wireless RF controller will then transmit an RF signal reporting activation of the emergency stop switch to the MCU in response to activation of the emergency stop switch. When the MCU receives an RF signal transmitted by the wireless RF controller reporting activation of the emergency stop switch or the MCU fails to receive any RF signal transmitted by the wireless RF controller (e.g., loss of communication, wireless RF controller out of range, wireless RF controller has a dead battery, fault in the MCU causes loss of communication with the wireless RF controller, other reason, etc.), the MCU will not close the normally open pneumatic valve. Air from the locomotive brake pipe may then vent outward through the open pneumatic valve to atmosphere, such that a braking force will be applied to the locomotive.

Also when the MCU fails to receive any RF signal from the wireless RF controller or the MCU receives an RF signal from the wireless RF controller reporting activation of the emergency stop switch, the MCU will turn off the normally open relay contact of the electromechanical relay that interfaces to the generator field switch and battery field circuit of the locomotive. The de-energizing of the normally open relay contact of the single electromechanical relay will interrupt the VDC (e.g., 72 VDC, etc.) from turning on the battery field of the locomotive, thus preventing locomotive tractive effort.

When the wireless RF controller's emergency stop switch is deactivated (e.g., by rotation and upward movement, etc.), the wireless RF controller recommences the continuous transmission of the RF signals to the MCU reporting normal operation. In response to the MCU again receiving the RF signals transmitted by the wireless RF controller reporting normal operation:
the normally open pneumatic valve will be closed by the MCU thus preventing any air from venting to atmosphere from the brake pipe of the locomotive, such that there is no braking force applied; and
the normally open relay contact of the single electromechanical relay will be closed such that the single electromechanical relay does not interrupt the VDC (e.g., 72vdc, etc.) from turning on the battery field of the locomotive and does not prevent locomotive tractive effort.

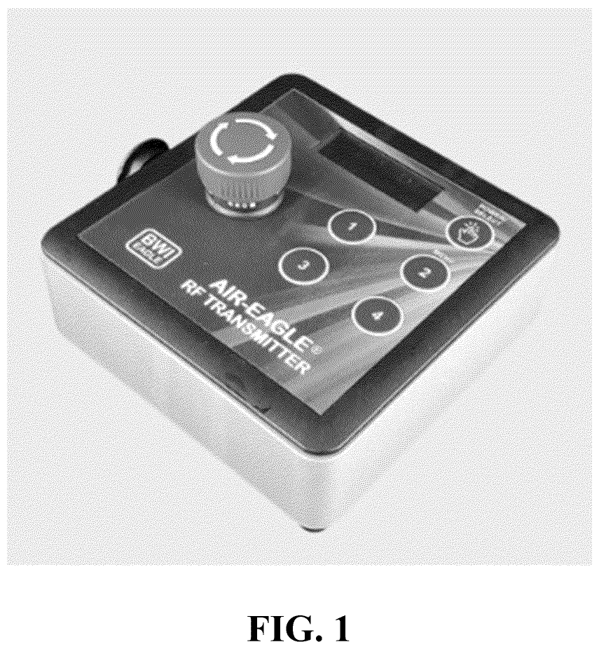

With reference now to the figures, FIG. 1 shows a locomotive handheld wireless emergency stop (E-Stop) device (broadly, a portable wireless radio frequency (RF) controller) according to an exemplary embodiment. The labeling on the E-Stop device is illustrative only and may be changed. The E-Stop device will be worn by an operator or other person seeking more safety when working in a rail environment.

The E-Stop device includes an emergency stop switch (e.g., large orange circular button or knob shown in FIG. 1, etc.). As disclosed herein, the E-Stop device is configured to continuously transmit RF signals to the MCU reporting normal operation and to transmit an RF signal to the MCU reporting activation of the emergency stop switch in response to activation of the emergency stop switch.

The emergency stop switch is activated when depressed to move the emergency stop switch sufficiently downward to latch the emergency stop switch in place in the depressed/downward activated position. The emergency stop switch is deactivated by rotating the emergency stop switch to unlatch the activated emergency stop switch. The unlatching allows upward movement (e.g., spring-loaded upward movement, etc.) of the emergency stop switch from the depressed/downward activated position in which the emergency stop switch is activated to an upward deactivated position in which the emergency stop switch is deactivated. The requirement of having to rotate the emergency stop switch to unlatch the activated emergency stop switch before allowing upward movement from the depressed/downward activated position to the upward deactivated position helps prevent the emergency stop switch when activated from being accidentally or inadvertently deactivated.

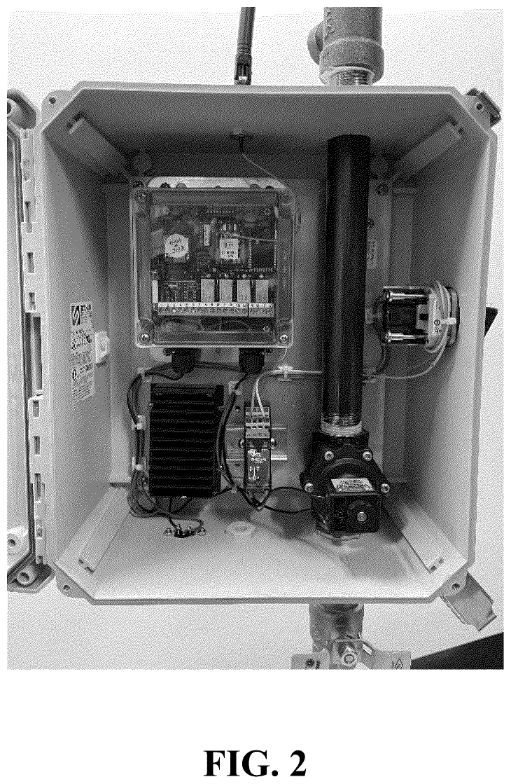

FIG. 2 shows a complete machine control unit (MCU) system that will be onboard the locomotive (e.g., mounted in the cab of the locomotive, etc.) according to an exemplary embodiment. The complete MCU system includes both the pneumatic and electrical connections to interface to a locomotive. The complete MCU system once installed can be selectively enabled (e.g., during locomotive operation, etc.) and selectively disabled. The complete MCU system preferably include a Lock Out Tag Out feature to prevent incorrect personnel from enabling or disabling the system.

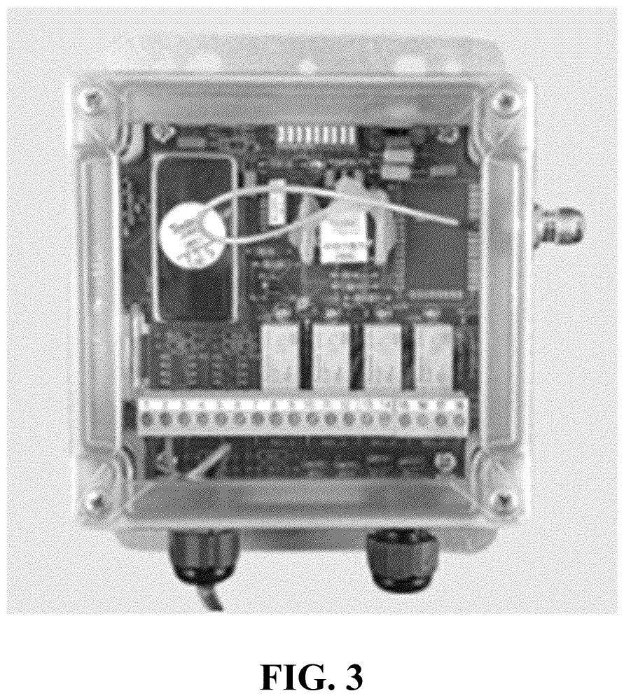

FIG. 3 shows the locomotive Machine Control Unit (MCU), which is part of the overall MCU system shown in FIG. 2.

Exemplary embodiments are disclosed herein of wireless locomotive emergency stop systems. In exemplary embodiments, a wireless locomotive emergency stop system comprises a machine control unit (MCU) positionable onboard a locomotive. The MCU includes a first pneumatic connection and a second electric connection distinct from the first pneumatic connection. The first pneumatic connection is configured to interface with a braking system of the locomotive. The second electrical connection configured to interface with a tractive effort system of the locomotive. The wireless locomotive emergency stop system further comprises a wireless radio frequency (RF) controller including an emergency stop switch. The wireless RF controller is configured to continuously transmit RF signals to the MCU reporting normal operation unless the emergency stop switch is activated. The wireless RF controller is configured to transmit an RF signal to the MCU reporting activation of the emergency stop switch in response to activation of the emergency stop switch. In response to the MCU receiving the RF signal transmitted by the wireless RF controller reporting normal operation, the MCU is configured such that: a normally open pneumatic valve is closed via the MCU's first pneumatic connection, to thereby prevent venting of air from the locomotive brake pipe through the pneumatic valve to atmosphere; and a normally open relay contact of an electromechanical relay that interfaces to a generator field switch and a battery field circuit of the locomotive is closed, whereby the relay contact of the electromechanical relay does not interrupt VDC from turning on a battery field of the locomotive that would otherwise prevent a locomotive tractive effort by the locomotive tractive effort system. In response to the MCU failing to receive any RF signal transmitted by the wireless RF controller or in response to the MCU receiving an RF signal transmitted by the wireless RF controller reporting activation of the emergency stop switch, the MCU is configured such that: the normally open pneumatic valve is open such that the opened pneumatic valve allows air from the locomotive brake pipe to vent through the opened pneumatic valve to atmosphere; and the normally open relay contact of the electromechanical relay is turned off via the MCU's second electrical connection, such that the de-energizing of the normally open relay contact of the electromechanical relay will interrupt the VDC from turning on the locomotive battery field and thereby prevent a locomotive tractive effort by the locomotive tractive effort system.

In exemplary embodiments, in response to the MCU losing communication with the wireless RF controller (e.g., wireless RF controller out of range, wireless RF controller has a dead battery, fault in the MCU causes loss of communication with the wireless RF controller, other reason, etc.), the MCU is configured such that: the normally open pneumatic valve is open such that the opened pneumatic valve allows air from the locomotive brake pipe to vent through the opened pneumatic valve to atmosphere; and the normally open relay contact of the electromechanical relay is turned off via the MCU's second electrical connection, such that the de-energizing of the normally open relay contact of the electromechanical relay will interrupt the VDC from turning on the locomotive battery field and thereby prevent a locomotive tractive effort by the locomotive tractive effort system.

In exemplary embodiments, the wireless RF controller may be configured to transmit continuous periodic RF signals to the MCU reporting normal operation. In response to the MCU failing to receive the continuous periodic RF signals from the wireless RF controller reporting normal operation after a specified period of time, the MCU may be configured such that: the normally open pneumatic valve is open such that the opened pneumatic valve allows air from the locomotive brake pipe to vent through the opened pneumatic valve to atmosphere; and the normally open relay contact of the electromechanical relay is turned off, such that the de-energizing of the normally open relay contact of the electromechanical relay will interrupt the VDC from turning on the locomotive battery field and thereby prevent a locomotive tractive effort by the locomotive tractive effort system.

In exemplary embodiments, a wireless locomotive emergency stop system comprises a machine control unit (MCU) positionable onboard a locomotive. The MCU includes a first pneumatic connection and a second electric connection distinct from the first pneumatic connection. The first pneumatic connection is configured to interface with a braking system of the locomotive. The second electrical connection is configured to interface with a tractive effort system of the locomotive. The wireless locomotive emergency stop system further comprises a wireless radio frequency (RF) controller including an emergency stop switch. The wireless RF controller is configured to continuously transmit RF signals to the MCU reporting normal operation unless the emergency stop switch is activated. The wireless RF controller is configured to transmit an RF signal to the MCU reporting activation of the emergency stop switch in response to activation of the emergency stop switch. In response to the MCU receiving the RF signal transmitted by the wireless RF controller reporting normal operation, the MCU is configured to: actuate a pneumatic valve, via the first pneumatic connection, to prevent venting of air from the locomotive brake pipe through the pneumatic valve to atmosphere; and allow VDC to turn on a battery field of the locomotive to enable a locomotive tractive effort by the locomotive tractive effort system. In response to the MCU failing to receive any RF signal transmitted by the wireless RF controller or in response to the MCU receiving an RF signal transmitted by the wireless RF controller reporting activation of the emergency stop switch, the MCU is configured to: allow air from the locomotive brake pipe to vent through the pneumatic valve to atmosphere; and interrupt the VDC, via the second electrical connection, from turning on the locomotive battery field and thereby prevent a locomotive tractive effort by the locomotive tractive effort system.

In exemplary embodiments, in response to the MCU losing communication with the wireless RF controller (e.g., wireless RF controller out of range, wireless RF controller has a dead battery, fault in the MCU causes loss of communication with the wireless RF controller, other reason, etc.), the MCU is configured to: allow air from the locomotive brake pipe to vent through the pneumatic valve to atmosphere; and interrupt the VDC, via the second electrical connection, from turning on the locomotive battery field and thereby prevent a locomotive tractive effort by the locomotive tractive effort system.

In exemplary embodiments, the wireless RF controller may be configured to transmit continuous periodic RF signals to the MCU reporting normal operation. In response to the MCU failing to receive the continuous periodic RF signals from the wireless RF controller reporting normal operation after a specified period of time, the MCU is configured to: allow air from the locomotive brake pipe to vent through the pneumatic valve to atmosphere; and interrupt the VDC, via the second electrical connection, from turning on the locomotive battery field and thereby prevent a locomotive tractive effort by the locomotive tractive effort system.

In exemplary embodiments, in response to the MCU receiving the RF signal transmitted by the wireless RF controller reporting normal operation, the MCU is configured to close a normally open relay contact of an electromechanical relay that interfaces to a generator field switch and a battery field circuit of the locomotive, whereby the relay contact of the electromechanical relay does not interrupt the VDC from turning on the battery field of the locomotive that would otherwise prevent a locomotive tractive effort by the locomotive tractive effort system. In response to the MCU failing to receive any RF signal transmitted by the wireless RF controller or in response to the MCU receiving an RF signal transmitted by the wireless RF controller reporting activation of the emergency stop switch, the MCU is configured to turn off the normally open relay contact of the electromechanical relay, via the MCU's second electrical connection, such that the de-energizing of the normally open relay contact of the electromechanical relay will interrupt the VDC from turning on the locomotive battery field and thereby prevent a locomotive tractive effort by the locomotive tractive effort system.

In exemplary embodiments, the pneumatic valve is a normally open pneumatic valve. In response to the MCU receiving the RF signal transmitted by the wireless RF controller reporting normal operation, the MCU is configured to close the normally open pneumatic valve, via the MCU's first pneumatic connection, to thereby prevent venting of air from the locomotive brake pipe through the pneumatic valve to atmosphere. In response to the MCU failing to receive any RF signal transmitted by the wireless RF controller or in response to the MCU receiving an RF signal transmitted by the wireless RF controller reporting activation of the emergency stop switch, the MCU is configured to not close the normally open pneumatic valve such that the opened pneumatic valve allows air from the locomotive brake pipe to vent through the opened pneumatic valve to atmosphere.

In exemplary embodiments, the first pneumatic connection is configured to be connected in parallel with a fireman's emergency brake handle of the locomotive.

In exemplary embodiments, the first pneumatic connection is connected in parallel with a fireman's emergency brake handle of the locomotive.

In exemplary embodiments, the first pneumatic connection is configured to provide a failsafe by means of connecting the normally open pneumatic valve in parallel to the fireman's emergency brake handle of the locomotive.

In exemplary embodiments, the MCU includes a single electromechanical relay configured to interface to a generator field circuit of the locomotive. The single electromechanical relay of the MCU includes a normally open relay contact configured to interface to a generator field switch and a battery field circuit of the locomotive. In response to the MCU receiving the RF signal transmitted by the wireless RF controller reporting normal operation, the MCU is configured to close the normally open relay contact of the single electromechanical relay, whereby the relay contact does not interrupt the VDC from turning on the battery field of the locomotive that would otherwise prevent a locomotive tractive effort by the locomotive tractive effort system. In response to the MCU failing to receive any RF signal transmitted by the wireless RF controller or in response to the MCU receiving an RF signal transmitted by the wireless RF controller reporting activation of the emergency stop switch, the MCU is configured to turn off the normally open relay contact of the single electromechanical relay, such that the de-energizing of the normally open relay contact of the single electromechanical relay will interrupt the VDC from turning on the locomotive battery field and thereby prevent a locomotive tractive effort by the locomotive tractive effort system.

In exemplary embodiments, in response to the MCU receiving the RF signal transmitted by the wireless RF controller reporting normal operation, the MCU is configured to close the normally open relay contact of the single electromechanical relay, whereby the relay contact does not interrupt a 72 VDC from turning on the battery field of the locomotive that would otherwise prevent a locomotive tractive effort by the locomotive tractive effort system. In response to the MCU failing to receive any RF signal transmitted by the wireless RF controller or in response to the MCU receiving an RF signal transmitted by the wireless RF controller reporting activation of the emergency stop switch, the MCU is configured to turn off the normally open relay contact of the single electromechanical relay, such that the de-energizing of the normally open relay contact of the single electromechanical relay will interrupt the 72 VDC from turning on the locomotive battery field and thereby prevent a locomotive tractive effort by the locomotive tractive effort system.

In exemplary embodiments, the wireless locomotive emergency stop system is configured to be operable as a standalone system without requiring the locomotive to be equipped with a remote control locomotive (RCL) system.

In exemplary embodiments, the wireless locomotive emergency stop system is operable with a first locomotive that does not have a radio remote control locomotive system and with a second locomotive that is equipped with a radio remote control system.

In exemplary embodiments, the wireless radio frequency (RF) controller is a portable personal safety device configured to be worn, located on, or otherwise carried by a person for additional safety when working on, near, on top of, and/or under rail car(s) or in any railroad operations where the person is not controlling the movement of the locomotive.

In exemplary embodiments, the wireless locomotive emergency stop system once installed on the locomotive can be selectively enabled during locomotive operation and selectively disabled.

In exemplary embodiments, the wireless locomotive emergency stop system is configured with lockout tagout capability to prevent incorrect personnel from selectively enabling or disabling the wireless locomotive emergency stop system.

In exemplary embodiments, the wireless locomotive emergency stop system is configured to: identify a user via an identification protocol; and allow the user to selectively enable or disable the wireless locomotive emergency stop system only when an authorized user is identified via the identification protocol. The identification protocol may include at least one of an RFID card and a biometric identifier; and authorization rights may be associated with the authorized user.

In exemplary embodiments, the emergency stop switch is configured to be: activated when depressed to move the emergency stop switch sufficiently downward to latch the emergency stop switch in place in a depressed/downward position in which the emergency stop switch is activated; and deactivated when the emergency stop switch is rotated to thereby unlatch the emergency stop switch and allow upward movement of the emergency stop switch from the depressed/downward position to an upward position in which the emergency stop switch is deactivated.

In exemplary embodiments, the wireless locomotive emergency stop system is configured to be operable as a standalone system without requiring the locomotive to be equipped with a remote control locomotive (RCL) system, whereby the wireless locomotive emergency stop system is operable both with a locomotive that does not have a radio remote control locomotive system and with a locomotive that is equipped with a radio remote control system.

Also disclosed are exemplary methods of providing locomotives with wireless emergency stop systems, and exemplary methods of using wireless locomotive emergency stop systems.

In exemplary methods of providing a locomotive with a wireless locomotive emergency stop system as disclosed herein, the method comprises selectively positioning the MCU onboard a first locomotive that does not have a radio remote control locomotive system or a second locomotive that is equipped with a radio remote control system, as the wireless locomotive emergency stop system is operable with locomotives without radio remote control systems and with locomotives equipped with radio remote control systems.

In an exemplary method of operating a wireless locomotive emergency stop system, the method comprises: continuously transmitting an RF signal from a wireless RF controller to an MCU reporting normal operation unless an emergency stop switch of the wireless RF controller has been activated; in response to activation of the emergency stop switch, transmitting an RF signal from the wireless RF controller to the MCU reporting activation of the emergency stop switch; in response to the MCU receiving the RF signal transmitted by the wireless RF controller reporting normal operation, preventing the venting of air from a locomotive brake pipe to atmosphere and enabling a locomotive tractive effort; and in response to the MCU failing to receive any RF signal transmitted by the wireless RF controller or in response to the MCU receiving an RF signal transmitted by the wireless RF controller reporting activation of the emergency stop switch, allowing air from the locomotive brake pipe to vent to atmosphere and preventing a locomotive tractive effort.

An exemplary method may include allowing air from the locomotive brake pipe to vent to atmosphere and preventing a locomotive tractive effort in response to the MCU losing communication with the wireless RF controller (e.g., wireless RF controller out of range, wireless RF controller has a dead battery, fault in the MCU causes loss of communication with the wireless RF controller, other reason, etc.).

An exemplary method may include transmitting continuous periodic RF signals from the wireless RF controller to the MCU reporting normal operation; and in response to the MCU failing to receive the continuous periodic RF signals from the wireless RF controller after a specified period of time, the method includes allowing air from the locomotive brake pipe to vent to atmosphere and preventing a locomotive tractive effort.

In exemplary methods, preventing the venting of air from a locomotive brake pipe to atmosphere comprises actuating a pneumatic valve to thereby prevent the venting of air from the locomotive brake through the pneumatic valve to atmosphere; enabling a locomotive tractive effort comprises allowing VDC to turn on a battery field of the; allowing air from the locomotive brake pipe to vent to atmosphere comprises allowing air from the locomotive brake pipe to vent through the pneumatic valve to atmosphere; and preventing the locomotive tractive effort comprises interrupting the VDC from turning on the locomotive battery field and thereby prevent the locomotive tractive effort.

In exemplary methods, preventing the venting of air from a locomotive brake pipe to atmosphere comprises the MCU closing a normally open pneumatic valve to thereby prevent the venting of air from the locomotive brake pipe through the pneumatic valve to atmosphere; enabling a locomotive tractive effort comprises the MCU energizing a normally open relay contact of an electromechanical relay that interfaces to a generator field switch and a battery field circuit of the locomotive, whereby the relay contact does not interrupt VDC from turning on a battery field of the locomotive that would otherwise prevent the locomotive tractive effort; allowing air from the locomotive brake pipe to vent to atmosphere comprises the MCU not closing the normally open pneumatic valve such that the opened pneumatic valve allows air from the locomotive brake pipe to vent through the opened pneumatic valve to atmosphere; and preventing the locomotive tractive effort comprises the MCU turning off the normally open relay contact of the electromechanical relay, such that the de-energizing of the normally open relay contact of the electromechanical relay will interrupt the VDC from

In exemplary methods, the MCU includes a pneumatic connection connected in parallel with a fireman's emergency brake handle of the locomotive.

In exemplary methods, the method includes operating the wireless locomotive emergency stop system as a standalone system in a locomotive that is not equipped with a remote control locomotive (RCL) system.

In exemplary methods, the method includes a person wearing or otherwise carrying the wireless RF controller for additional safety when working on, near, on top of, and/or under rail car(s) or in any railroad operations where the person is not controlling the movement of the locomotive.

In exemplary methods, the method includes selectively enabling the wireless locomotive emergency stop system during locomotive operation and selectively disabling the wireless locomotive emergency stop system.

In exemplary methods, the method includes preventing incorrect personnel from selectively enabling or disabling the wireless locomotive emergency stop system.

In exemplary methods, the method includes allowing a user to selectively enable or disable the wireless locomotive emergency stop system only when an authorized user is identified via an identification protocol.

In exemplary methods, the method includes: activating the emergency stop switch by depressing the emergency stop switch sufficiently downward to latch the emergency stop switch in place in a depressed/downward position in which the emergency stop switch is activated; and deactivating the emergency stop switch by rotating the emergency stop switch to thereby unlatch the emergency stop switch and allow upward movement of the emergency stop switch from the depressed/downward position to an upward position in which the emergency stop switch is deactivated.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A wireless locomotive emergency stop system comprising:
a machine control unit (MCU) positionable onboard a locomotive, the MCU including a first pneumatic connection and a second electric connection distinct from the first pneumatic connection, the first pneumatic connection configured to interface with a braking system of the locomotive, the second electrical connection configured to interface with a tractive effort system of the locomotive; and
a wireless radio frequency (RF) controller including an emergency stop switch, the wireless RF controller configured to continuously transmit RF signals to the MCU reporting normal operation unless the emergency stop switch is activated, the wireless RF controller configured to transmit an RF signal to the MCU reporting activation of the emergency stop switch in response to activation of the emergency stop switch;
wherein in response to the MCU receiving an RF signal transmitted by the wireless RF controller reporting normal operation, the MCU is configured to:
actuate a pneumatic valve, via the first pneumatic connection, to prevent venting of air from a locomotive brake pipe through the pneumatic valve to atmosphere; and
allow VDC to turn on a battery field of the locomotive to enable a locomotive tractive effort by the tractive effort system;
wherein in response to the MCU failing to receive any RF signal transmitted by the wireless RF controller or in response to the MCU receiving an RF signal transmitted by the wireless RF controller reporting activation of the emergency stop switch, the MCU is configured to:
allow air from the locomotive brake pipe to vent through the pneumatic valve to atmosphere; and
interrupt the VDC, via the second electrical connection, from turning on a locomotive battery field and thereby prevent a locomotive tractive effort by the tractive effort system.

2. The wireless locomotive emergency stop system of claim 1, wherein in response to the MCU losing communication with the wireless RF controller, the MCU is configured to:
allow air from the locomotive brake pipe to vent through the pneumatic valve to atmosphere; and
interrupt the VDC, via the second electrical connection, from turning on the locomotive battery field and thereby prevent a locomotive tractive effort by the tractive effort system.

3. The wireless locomotive emergency stop system of claim 1, wherein:
in response to the MCU receiving an RF signal transmitted by the wireless RF controller reporting normal operation, the MCU is configured to close a normally open relay contact of an electromechanical relay that interfaces to a generator field switch and a battery field circuit of the locomotive, whereby the relay contact of the electromechanical relay does not interrupt the VDC from turning on the battery field of the locomotive that would otherwise prevent a locomotive tractive effort by the tractive effort system; and
in response to the MCU failing to receive any RF signal transmitted by the wireless RF controller or in response to the MCU receiving an RF signal transmitted by the wireless RF controller reporting activation of the emergency stop switch, the MCU is configured to turn off the normally open relay contact of the electromechanical relay, via the MCU's second electrical connection, such that the de-energizing of the normally open relay contact of the electromechanical relay will interrupt the VDC from turning on the locomotive battery field and thereby prevent a locomotive tractive effort by the tractive effort system.

4. The wireless locomotive emergency stop system of claim 1, wherein:
the pneumatic valve is a normally open pneumatic valve;
in response to the MCU receiving an RF signal transmitted by the wireless RF controller reporting normal operation, the MCU is configured to close the normally open pneumatic valve, via the MCU's first pneumatic connection, to thereby prevent venting of air from the locomotive brake pipe through the pneumatic valve to atmosphere; and
in response to the MCU failing to receive any RF signal transmitted by the wireless RF controller or in response to the MCU receiving an RF signal transmitted by the wireless RF controller reporting activation of the emergency stop switch, the MCU is configured to not close the normally open pneumatic valve such that the opened pneumatic valve allows air from the locomotive brake pipe to vent through the opened pneumatic valve to atmosphere.

5. The wireless locomotive emergency stop system of claim 1, wherein the pneumatic valve is a normally open pneumatic valve, and:
wherein in response to the MCU receiving an RF signal transmitted by the wireless RF controller reporting normal operation, the MCU is configured such that:
the normally open pneumatic valve is closed via the MCU's first pneumatic connection, to thereby prevent venting of air from the locomotive brake pipe through the pneumatic valve to atmosphere; and
a normally open relay contact of an electromechanical relay that interfaces to a generator field switch and a battery field circuit of the locomotive is closed, whereby the relay contact of the electromechanical relay does not interrupt VDC from turning on a battery field of the locomotive that would otherwise prevent a locomotive tractive effort by the tractive effort system;
wherein in response to the MCU failing to receive any RF signal transmitted by the wireless RF controller or in response to the MCU receiving an RF signal transmitted by the wireless RF controller reporting activation of the emergency stop switch, the MCU is configured such that:
the normally open pneumatic valve is open such that the opened pneumatic valve allows air from the locomotive brake pipe to vent through the opened pneumatic valve to atmosphere; and
the normally open relay contact of the electromechanical relay is turned off via the MCU's second electrical connection, such that the de-energizing of the normally open relay contact of the electromechanical relay will interrupt the VDC from turning on the locomotive battery field and thereby prevent a locomotive tractive effort by the tractive effort system.

6. The wireless locomotive emergency stop system of claim 5, wherein in response to the MCU losing communication with the wireless RF controller, the MCU is configured such that:
the normally open pneumatic valve is open such that the opened pneumatic valve allows air from the locomotive brake pipe to vent through the opened pneumatic valve to atmosphere; and
the normally open relay contact of the electromechanical relay is turned off via the MCU's second electrical connection, such that the de-energizing of the normally open relay contact of the electromechanical relay will interrupt the VDC from turning on the locomotive battery field and thereby prevent a locomotive tractive effort by the tractive effort system.

7. The wireless locomotive emergency stop system of claim 1, wherein the first pneumatic connection is configured to be connected in parallel with a fireman's emergency brake handle of the locomotive.

8. The wireless locomotive emergency stop system of claim 1, wherein the first pneumatic connection is connected in parallel with a fireman's emergency brake handle of the locomotive.

9. The wireless locomotive emergency stop system of claim 1, wherein the first pneumatic connection is configured to provide a failsafe by means of connecting the normally open pneumatic valve in parallel to a fireman's emergency brake handle of the locomotive.

10. The wireless locomotive emergency stop system of claim 1, wherein the MCU includes a single electromechanical relay configured to interface to a generator field circuit of the locomotive.

11. The wireless locomotive emergency stop system of claim 10, wherein:
the single electromechanical relay of the MCU includes a normally open relay contact configured to interface to a generator field switch and a battery field circuit of the locomotive;
in response to the MCU receiving an RF signal transmitted by the wireless RF controller reporting normal operation, the MCU is configured to close the normally open relay contact of the single electromechanical relay, whereby the relay contact does not interrupt the VDC from turning on the battery field of the locomotive that would otherwise prevent a locomotive tractive effort by the tractive effort system; and
in response to the MCU failing to receive any RF signal transmitted by the wireless RF controller or in response to the MCU receiving an RF signal transmitted by the wireless RF controller reporting activation of the emergency stop switch, the MCU is configured to turn off the normally open relay contact of the single electromechanical relay, such that the de-energizing of the normally open relay contact of the single electromechanical relay will interrupt the VDC from turning on the locomotive battery field and thereby prevent a locomotive tractive effort by the tractive effort system.

12. The wireless locomotive emergency stop system of claim 11, wherein:
in response to the MCU receiving an RF signal transmitted by the wireless RF controller reporting normal operation, the MCU is configured to close the normally open relay contact of the single electromechanical relay, whereby the relay contact does not interrupt a 72 VDC from turning on the battery field of the locomotive that would otherwise prevent a locomotive tractive effort by the tractive effort system; and
in response to the MCU failing to receive any RF signal transmitted by the wireless RF controller or in response to the MCU receiving an RF signal transmitted by the wireless RF controller reporting activation of the emergency stop switch, the MCU is configured to turn off the normally open relay contact of the single electromechanical relay, such that the de-energizing of the normally open relay contact of the single electromechanical relay will interrupt the 72 VDC from turning on the locomotive battery field and thereby prevent a locomotive tractive effort by the tractive effort system.

13. The wireless locomotive emergency stop system of claim 1, wherein the wireless locomotive emergency stop system is configured to be operable as a standalone system without requiring the locomotive to be equipped with a remote control locomotive (RCL) system.

14. The wireless locomotive emergency stop system of claim 1, wherein the wireless locomotive emergency stop system is operable with a first locomotive that does not have a radio remote control locomotive system and with a second locomotive that is equipped with a radio remote control system.

15. The wireless locomotive emergency stop system of claim 1, wherein the wireless radio frequency (RF) controller is a portable personal safety device configured to be worn, located on, or otherwise carried by a person for additional safety when working on, near, on top of, and/or under rail car(s) or in any railroad operations where the person is not controlling the movement of the locomotive.

16. The wireless locomotive emergency stop system of claim 1, wherein the wireless locomotive emergency stop system once installed on the locomotive can be selectively enabled during locomotive operation and selectively disabled.

17. The wireless locomotive emergency stop system of claim 1, wherein the wireless locomotive emergency stop system is configured with lockout tagout capability to prevent incorrect personnel from selectively enabling or disabling the wireless locomotive emergency stop system.

18. The wireless locomotive emergency stop system of claim 1, wherein the emergency stop switch is configured to be:
activated when depressed to move the emergency stop switch sufficiently downward to latch the emergency stop switch in place in a depressed/downward position in which the emergency stop switch is activated; and
deactivated when the emergency stop switch is rotated to thereby unlatch the emergency stop switch and allow upward movement of the emergency stop switch from the depressed/downward position to an upward position in which the emergency stop switch is deactivated.

19. A method of operating a wireless locomotive emergency stop system, the method comprising:
continuously transmitting an RF signal from a wireless RF controller to an MCU reporting normal operation unless an emergency stop switch of the wireless RF controller has been activated;
in response to activation of the emergency stop switch, transmitting an RF signal from the wireless RF controller to the MCU reporting activation of the emergency stop switch;
in response to the MCU receiving the RF signal transmitted by the wireless RF controller reporting normal operation, preventing the venting of air from a locomotive brake pipe to atmosphere and enabling a locomotive tractive effort; and
in response to the MCU failing to receive any RF signal transmitted by the wireless RF controller or in response to the MCU receiving an RF signal transmitted by the wireless RF controller reporting activation of the emergency stop switch, allowing air from the locomotive brake pipe to vent to atmosphere and preventing a locomotive tractive effort.

20. The method of claim 19, wherein the method includes allowing air from the locomotive brake pipe to vent to atmosphere and preventing a locomotive tractive effort in response to the MCU losing communication with the wireless RF controller.

21. The method of claim 19, wherein:
preventing the venting of air from a locomotive brake pipe to atmosphere comprises actuating a pneumatic valve to thereby prevent the venting of air from the locomotive brake through the pneumatic valve to atmosphere;
enabling a locomotive tractive effort comprises allowing VDC to turn on a battery field of the locomotive;
allowing air from the locomotive brake pipe to vent to atmosphere comprises allowing air from the locomotive brake pipe to vent through the pneumatic valve to atmosphere; and
preventing the locomotive tractive effort comprises interrupting the VDC from turning on the locomotive battery field and thereby preventing the locomotive tractive effort.

22. The method of claim 19, wherein:
preventing the venting of air from a locomotive brake pipe to atmosphere comprises the MCU closing a normally open pneumatic valve to thereby prevent the venting of air from the locomotive brake pipe through the pneumatic valve to atmosphere;
enabling a locomotive tractive effort comprises the MCU energizing a normally open relay contact of an electromechanical relay that interfaces to a generator field switch and a battery field circuit of the locomotive, whereby the relay contact does not interrupt VDC from turning on a battery field of the locomotive that would otherwise prevent the locomotive tractive effort;
allowing air from the locomotive brake pipe to vent to atmosphere comprises the MCU not closing the normally open pneumatic valve such that the opened pneumatic valve allows air from the locomotive brake pipe to vent through the opened pneumatic valve to atmosphere; and
preventing the locomotive tractive effort comprises the MCU turning off the normally open relay contact of the electromechanical relay such that the de-energizing of the normally open relay contact of the electromechanical relay will interrupt the VDC from turning on the locomotive battery field and thereby prevent the locomotive tractive effort.

23. The method of claim 19, wherein the MCU includes a pneumatic connection connected in parallel with a fireman's emergency brake handle of the locomotive.

24. The method of claim 19, wherein the method includes operating the wireless locomotive emergency stop system as a standalone system in a locomotive that is not equipped with a remote control locomotive (RCL) system.

25. The method of claim 19, wherein the method includes a person wearing or otherwise carrying the wireless RF controller for additional safety when working on, near, on top of, and/or under rail car(s) or in any railroad operations where the person is not controlling the movement of the locomotive.

26. The method of claim 19, wherein the method includes selectively enabling the wireless locomotive emergency stop system during locomotive operation and selectively disabling the wireless locomotive emergency stop system.

27. The method of claim 19, wherein the method includes preventing incorrect personnel from selectively enabling or disabling the wireless locomotive emergency stop system.

28. The method of claim 19, wherein the method includes:
activating the emergency stop switch by depressing the emergency stop switch sufficiently downward to latch the emergency stop switch in place in a depressed/downward position in which the emergency stop switch is activated; and
deactivating the emergency stop switch by rotating the emergency stop switch to thereby unlatch the emergency stop switch and allow upward movement of the emergency stop switch from the depressed/downward position to an upward position in which the emergency stop switch is deactivated.

29. The method of claim 19, wherein the method comprises selectively positioning the MCU onboard a first locomotive that does not have a radio remote control locomotive system or a second locomotive that is equipped with a radio remote control system, as the wireless locomotive emergency stop system is operable with locomotives without radio remote control systems and with locomotives equipped with radio remote control systems.
